(19) United States
(12) Patent Application Publication
(10) Pub. No.: US 2022/0320535 A1
(43) Pub. Date: Oct. 6, 2022

(54) FUEL CELL POWER SYSTEMS

(71) Applicant: UltraCell LLC, Livermore, CA (US)

(72) Inventors: Ian W. KAYE, Livermore, CA (US); Ru CHEN, Dublin, CA (US); Franklin Paul BARCINAS, Stockton, CA (US); John Ryan MURPHY, Dublin, CA (US); Jonathan ABENA, Martinez, CA (US); Alan D. WILSON, Romulus, MI (US)

(21) Appl. No.: 17/711,846

(22) Filed: Apr. 1, 2022

Related U.S. Application Data
(60) Provisional application No. 63/170,065, filed on Apr. 2, 2021.
(60) Provisional application No. 63/214,959, filed on Jun. 25, 2021.

(51) Int. Cl. H01M 8/04858; H01M 8/249; H01M 8/04701; H01M 8/04007; H01M 8/04029; H01M 8/04537; H01M 8/0432; H01M 8/04955

(52) U.S. Cl. CPC H01M 8/0494; H01M 8/249; H01M 8/04701; H01M 8/04067; H01M 8/04029; H01M 8/04559; H01M 8/0432; H01M 8/04955; H02J 1/00

(57) ABSTRACT

A fuel cell power system that includes multiple strings that each have multiple sub-stacks of fuel cells. Each sub-stack is electrically isolated from other sub-stacks and each sub-stack can be independently controlled by a DC control module on a printed circuit board. The DC control module of a sub-stack can regulate or shut off the output power of the sub-stack if the sub-stack becomes weak or fails. A sub-stack can be shut off while other sub-stacks in the system continue to operate. The output power of other sub-stacks can be increased to compensate for sub-stacks that are shut down.

### RELATED APPLICATIONS

This application claims the benefit of U.S. Provisional Application No. 63/170,065, filed on Apr. 2, 2021, and U.S. Provisional Application No. 63/214,959, filed on Jun. 25, 2021. Each of the foregoing applications is hereby incorporated by reference herein for all purposes

### BACKGROUND OF THE INVENTION

The present disclosure generally relates to fuel cells. More specifically, the disclosure relates to fuel cell power systems for reliably powering a variety of systems.

Fuel cells can be used in a wide range of applications, including transportation, material handling, stationary, and portable power applications. Typically, fuel cells are connected in series to provide the desired voltage and power. For example, a Toyota Mirai fuel cell passenger sedan has 330 fuel cells. A Novistar semi-truck has two Hydrotec fuel cell modules made by General Motors, with each Hydrotec fuel cell module having 304 fuel cells. Fuel cells are expected to have a long operating lifetime. The target operating lifetime for Class 8 long-haul tractor-trailers powered by fuel cells is 30,000 hours, while the operating lifetime of stationary fuel cell systems is about 60,000 — 80,000 hours. To achieve the operating lifetime targets, progress must be made in fuel cell technology to improve fuel cell durability. In addition, fuel cell systems must be designed to be very reliable. Therefore, it would be desirable to be able to durable provide fuel cell power systems that are capable of providing the desired power.

### SUMMARY OF THE INVENTION

In accordance with an embodiment, a fuel cell power system is provided. The fuel cell power system includes at least one fuel cell string, a plurality of DC control modules, and a master system controller. The at least one fuel cell string includes a plurality of fuel cell sub-stacks that are electrically isolated from one another. Each sub-stack includes a plurality of fuel cells. The DC control modules are configured to control the sub-stacks and the outputs of the DC control modules are connected in series. A different DC control module is configured to control each sub-stack, and each of the DC control modules is capable of controlling a magnitude of output power of its corresponding sub-stack independently of other sub-stacks. The master system controller is in communication with the plurality of DC control modules, and the master system controller receives data from the DC control modules and sends commands to the DC control modules.

In accordance with another embodiment, a method is provided for controlling a fuel cell power system including a plurality of fuel cell sub-stacks. The voltage output and current output from each of the sub-stacks and temperature of one or more of the sub-stacks are monitored. The output power of a sub-stack is reduced if the voltage for a given current of the sub-stack is greater than about 70% of rated performance for the sub-stack and less than about 90% of rated performance for the sub-stack while other sub-stacks output more than about 90% of rated performance. The output of a sub-stack is shut off if the voltage for a given current of the sub-stack is less than about 70% of rated performance for the sub-stack while other sub-stacks output more than about 90% of rated performance for the sub-stack.

In accordance with yet another embodiment, fuel cell power system is provided. The fuel cell power system includes at least one fuel cell string, a plurality of DC control modules configured to control the sub-stacks, and a master system controller in communication with the plurality of DC control modules. The at least one fuel cell string includes a plurality of fuel cell sub-stacks, and the sub-stacks are electrically isolated from one another. Each sub-stack includes a plurality of fuel cells. The outputs of the DC control modules are connected in series and a different DC control module is configured to control each sub-stack. Each of the DC control modules is capable of reducing an output power of its corresponding sub-stack independently of other sub-stacks if performance of the corresponding sub-stack is below about 90% of rated performance for the sub-stack while other sub-stacks output more than about 90% of rated performance. The performance is voltage output for a given current of the sub-stack and the rated performance for the sub-stack is provided by a polarization curve for the sub-stack at the given current. The master system controller receives data from the DC control modules and sends commands to the DC control modules.

### BRIEF DESCRIPTION OF THE DRAWINGS

The invention, together with further objects and advantages thereof, may best be understood by reference to the following description taken in conjunction with the accompanying drawings in which:

FIG. 1A is a schematic diagram of a fuel cell power system in accordance with an embodiment.

FIG. 1B is an exploded view of a fuel cell in a fuel cell power system in accordance with an embodiment.

FIG. 1C is a perspective view of a fuel cell power system in accordance with another embodiment.

FIG. 1D shows the circuitry of a printed circuit board for controlling a sub-stack in accordance with an embodiment.

FIG. 2 is a perspective view of a fuel cell stack in accordance with an embodiment.

FIG. 3 is a side view of the fuel cell stack shown in FIG. 2.

FIG. 4 is an end view of the fuel cell stack shown in FIGS. 2 and 3.

FIG. 5 shows a chart and graph of the relationship between power and the number of sub-stacks in accordance with an embodiment.

FIG. 6 is a schematic diagram showing the electrical connection of sub-stacks in a fuel cell power system according to an embodiment.

FIG. 7 is schematic diagram showing the electrical connection of sub-stacks in a fuel cell power system according to another embodiment.

FIG. 8 is a schematic diagram showing the electrical connection of sub-stacks individually controlled DC control modules in a fuel cell power system according to an embodiment.

FIG. 9 is a flow chart of a startup procedure for a fuel cell power system in accordance with an embodiment.

FIG. 10 is an example of a graphical user interface (GUI) for controlling a fuel cell power system in accordance with an embodiment.

FIG. 11 is a schematic diagram of a control system of a fuel cell power system in accordance with an embodiment.

FIG. 12 is a schematic diagram of a thermal management system for a fuel cell power system in accordance with an embodiment.

FIG. 13 is a perspective view of a fuel cell power system in accordance with an embodiment.

FIG. 14 shows exemplary edge cooling plates.

FIG. 15 shows exemplary polarization curves for fuel cells.

### DETAILED DESCRIPTION OF THE PREFERRED EMBODIMENTS

The present invention relates generally to fuel cell power systems. In a typical fuel cell stack, individual cells are connected in series to provide the desired voltage and power. If one cell in the stack fails or becomes weak, typically the entire stack will shut down and stop functioning completely. Embodiments of fuel cell power systems described herein can continue to function and generate power even if one or more fuel cells become weak or fail.

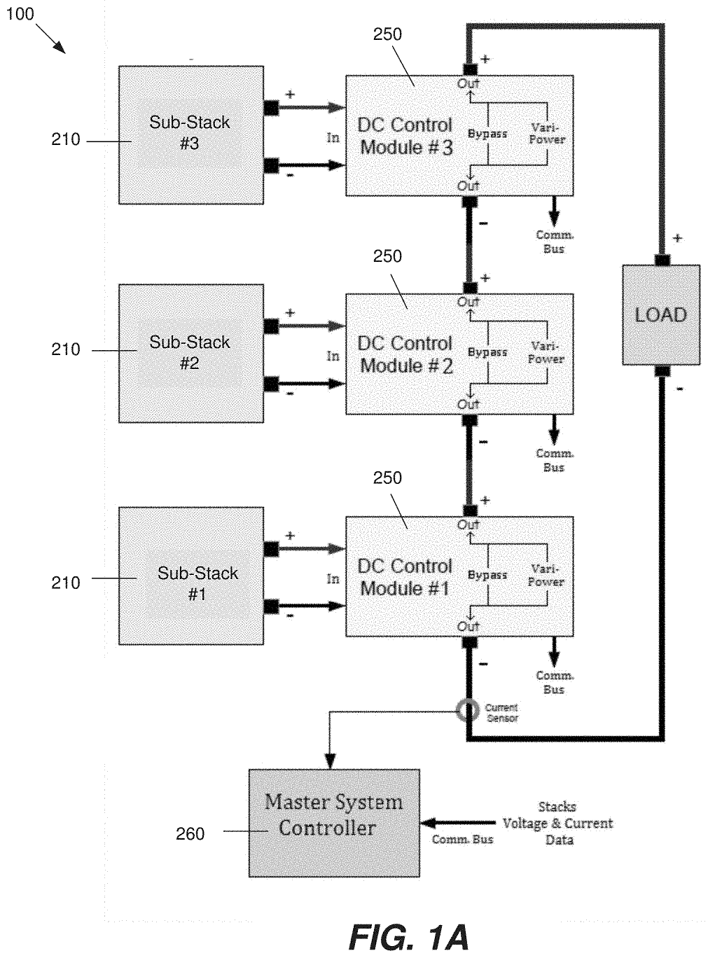

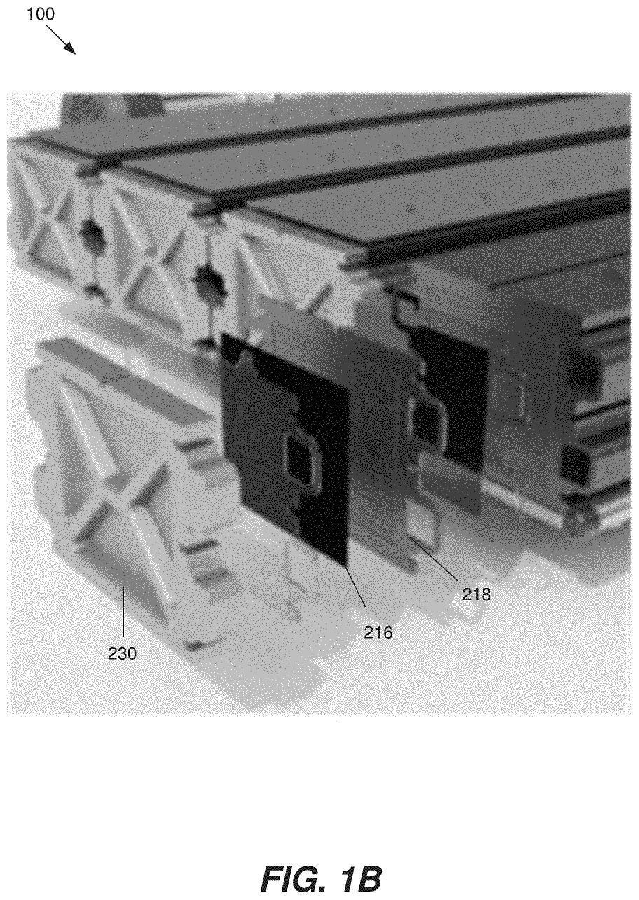

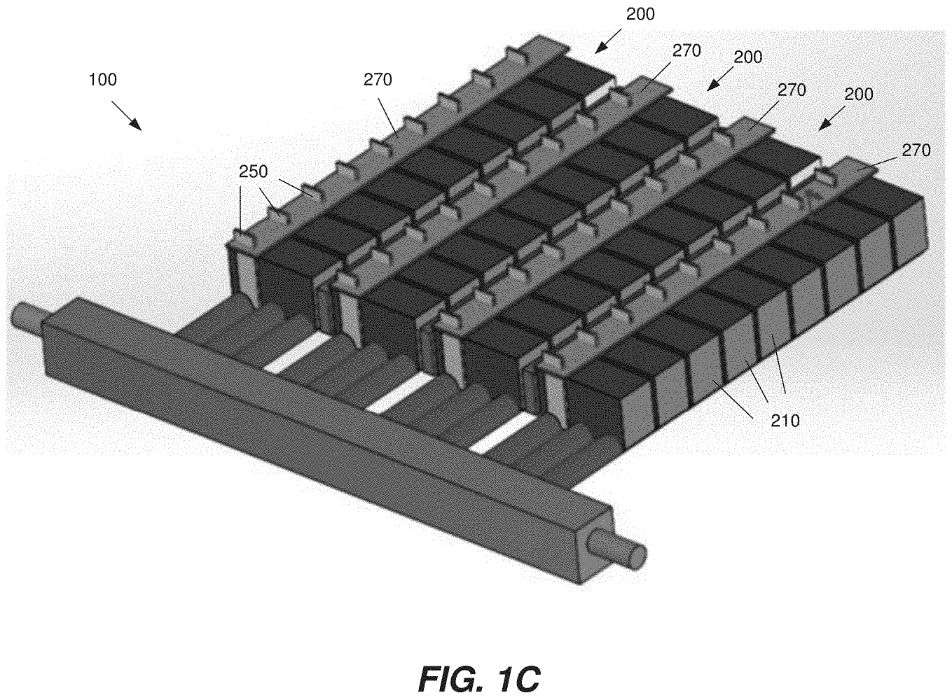

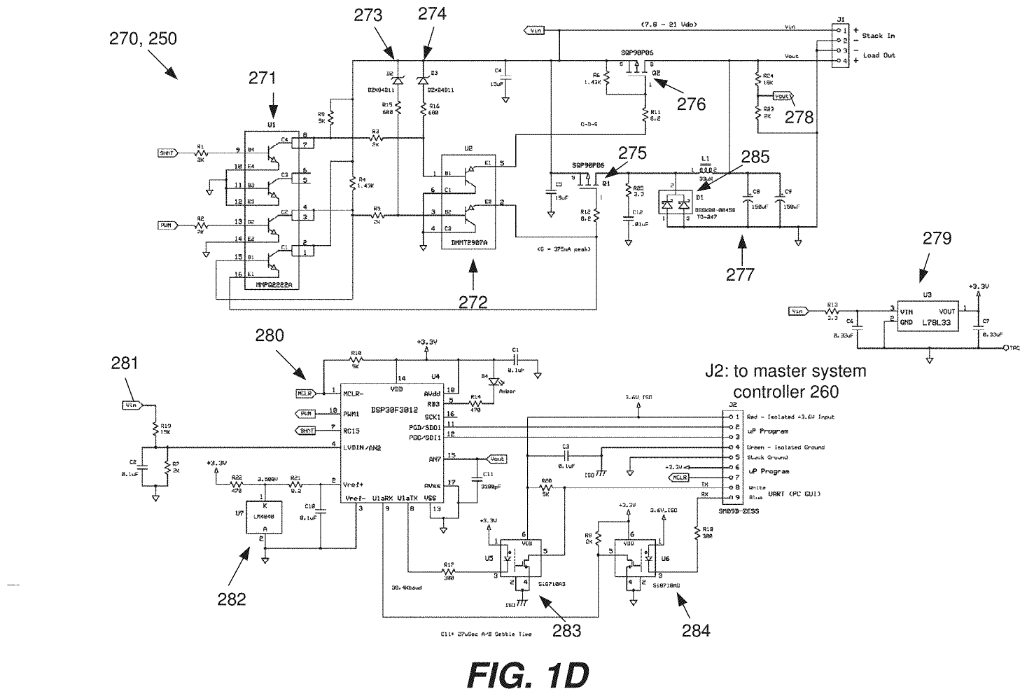

Fuel cell power systems 100 having multiple strings 200 including multiple sub-stacks 210 of fuel cells 212 that can be independently controlled are described herein. A schematic diagram of an embodiment of a fuel cell power system 100 is shown in FIG. 1A. The fuel cell power system 100 is capable of generating electric power with high voltages and low currents. Multiple strings 200 can be joined in series, parallel, or a combination of series and parallel to generate more power.

As shown in the embodiment in FIG. 1A, each of the sub-stacks 210 is connected to a DC control module 250 that is capable of controlling the sub-stack 210 independently from other sub-stacks. It will be understood that a fuel cell power system 100 can include any number of strings 200 and that the number of strings 200 and the total number of sub-stacks 210 and fuel cells 212 depends on the power requirements.

According to an embodiment shown in FIG. 1B, the cells 212 can be polymer electrolyte membrane (PEM) fuel cells having a membrane electrode assembly (MEA) 216. Bipolar plates 218 are positioned between individual fuel cells 212 to separate them and provide electrical connection between the cells 212. The bipolar plates 218 also provide physical structure and allow the stacking of individual fuel cells 212 into sub-stacks 210 and strings 200 to provide higher voltages. In some embodiments, the fuel cell power system 100 is fueled by hydrogen-rich gases produced by reforming methanol, natural gas, or liquefied petroleum gas, etc. It will be understood that, in other embodiments, the fuel cell power system 100 can be fueled by other fuels, such as hydrogen. It will be understood that any other types of fuel cells can be used in a fuel cell power system 100, including solid acid fuel cells, solid oxide fuel cells, phosphoric acid fuel cells, molten carbonate fuel cells, and alkaline fuel cells.

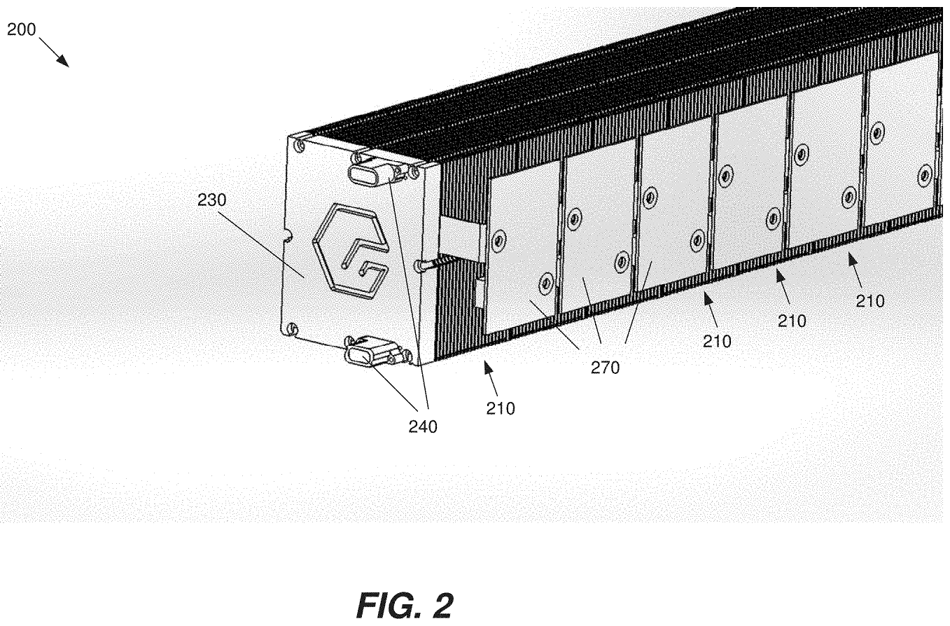

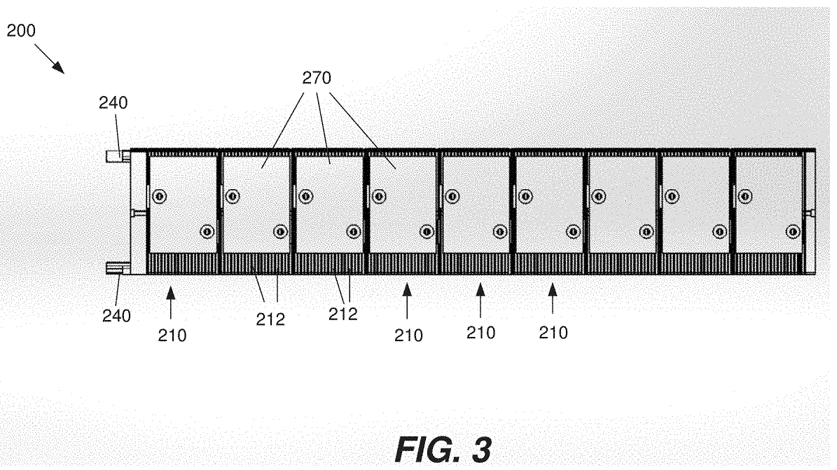

In this fuel cell power system 100, each string 200 is divided into multiple sub-stacks 210. According to an embodiment shown in FIGS. 2-4, a string 200 having nine sub-stacks 210 is shown. In this embodiment, there are 20 cells in each sub-stack 210, for a total of 180 cells in a string 200. Each sub-stack 210 has a DC control module 250 for power regulation. In the embodiment illustrated in FIGS. 2-4, a printed circuit board (PCB) 270 is mounted directly on each of the sub-stacks 210. According to this embodiment, each PCB 270 includes a DC control module 250. The output voltage of each sub-stack 210 can be independently controlled by a DC control module 250, as will be described in more detail below.

It will be understood that a PCB 270 can control any number of sub-stacks 210, but that each of the sub-stacks 210 is controlled by its own DC control module 250 and is controlled independently (i.e., electrically isolated) from the other sub-stacks 210. For example, in one embodiment, each sub-stack 210 is controlled by its own DC control module 250 on its own PCB 270; in another embodiment, a PCB 270 has three different DC control modules 250, each controlling its own sub-stack 210 (but each sub-stack is controlled individually where one sub-stack 210 can be shut off and the other two-stacks 210 remain on). In yet another embodiment, each PCB 270 has nine DC control modules 250, each controlling its own sub-stack 210 (as shown in FIG. 1C).

FIG. 1D shows the circuitry of a PCB 270 containing one DC control module 250 in accordance with an embodiment. It will be understood that, in other embodiments, a PCB 270 may contain multiple DC control modules 250. As shown in FIG. 1D, the DC control module 250 includes a positive gate driver 271, a negative gate driver 272, voltage limiters 273, 274, a “buck” transistor 275, a “shunt” transistor 276, a DC filter network 277, a module voltage sensor 278, a voltage regulator 279, a microcontroller chip 280, a sub-stack voltage sensor 281, voltage reference 282, and voltage isolators 283, 284. As shown in FIG. 1D, the DC control module 250 is in communication with the master system controller 260 to send and receive data and commands. It will be understood that, as used herein, the “Vari-power” circuit includes the positive gate driver 271, the negative gate driver 272, voltage limiters 273, 274, the “buck” “ransistor” 275, and DC filter network 277. The bypass switch 285 is part of the DC filter network 277, as shown in FIG. 1D.

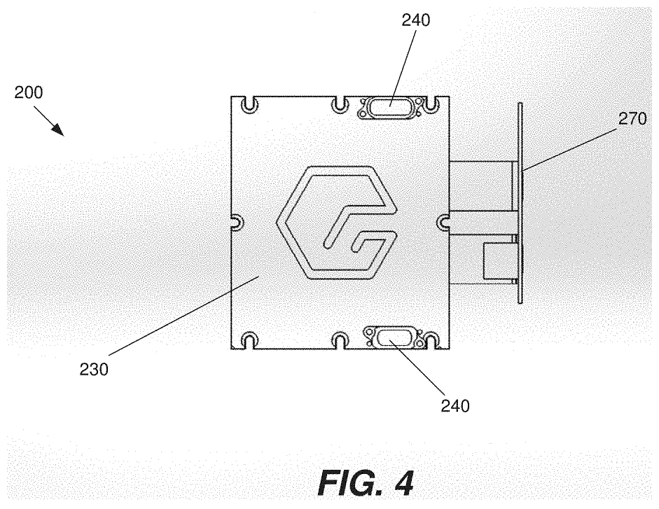

As noted above, each sub-stack 210 includes multiple fuel cells 212. The sub-stacks 210 are joined together into strings 200 in a power network to provide electrical power to an external load. FIG. 4 is an end view of a string 200, showing the fuel cell endplate 230. As shown in FIG. 4, the endplate 230 has two manifolds 240 through which fuel/air is flowed.

In embodiments described herein, when one cell 212 is fails, the sub-stack 210 that contains the failed cell 212 can be shut down by a DC control module 250 and removed from the power network to protect and allow the other sub-stacks 210 to continue to operate and generate power. Shutting down a sub-stack 210 containing failed cell 212 protects the rest of the system 100; if current is allowed to continue to flow through weak electrodes in the failed cell 212, it can cause the cell voltage to become negative and cause localized heat generation, which may cause a fire or even an explosion.

An example of a fuel cell power system 100 having four strings 200 is shown in Table 1. According to this embodiment, each string 200 has 180 cells 212. Each string 200 has nine sub-stacks 210, with each sub-stack 210 having 20 cells 212. To demonstrate the reliability of the fuel cell power system 100, the cell failure rate is assumed to be 0.5%. Thus, in a worst case scenario, there might be four cells failing prematurely before its expected end-of-life. The failed cells may be located in different sub-stacks 210. The fuel cell power system 100 can remove these four failed sub-stacks from the power network and to allow the other sub-stacks to continue to operate.

TABLE 1

| | | |
|---|---|---|
| Number of Cells | | 720 |
| Number of Sub-Stacks | | 36 |
| Number of Cells/Sub-Stack | | 20 |
| Number of Strings | | 4 |
| Number of Sub-Stacks/String | | 9 |
| Number of Cells/String | | 180 |
| Cell Active Area | cm² | 45 |
| Cell Voltage | V | 0.6 |
| Current Density | A/cm² | 0.8 |
| Sub-Stack Current | A | 36 |
| Sub-Stack Voltage | V | 12 |
| Sub-Stack Power | W | 432 |
| String Current | A | 36 |
| String Voltage | V | 108 |
| String Power | W | 3,888 |
| System Current | A | 36 |
| System Voltage | V | 432 |
| System Power | W | 15,552 |

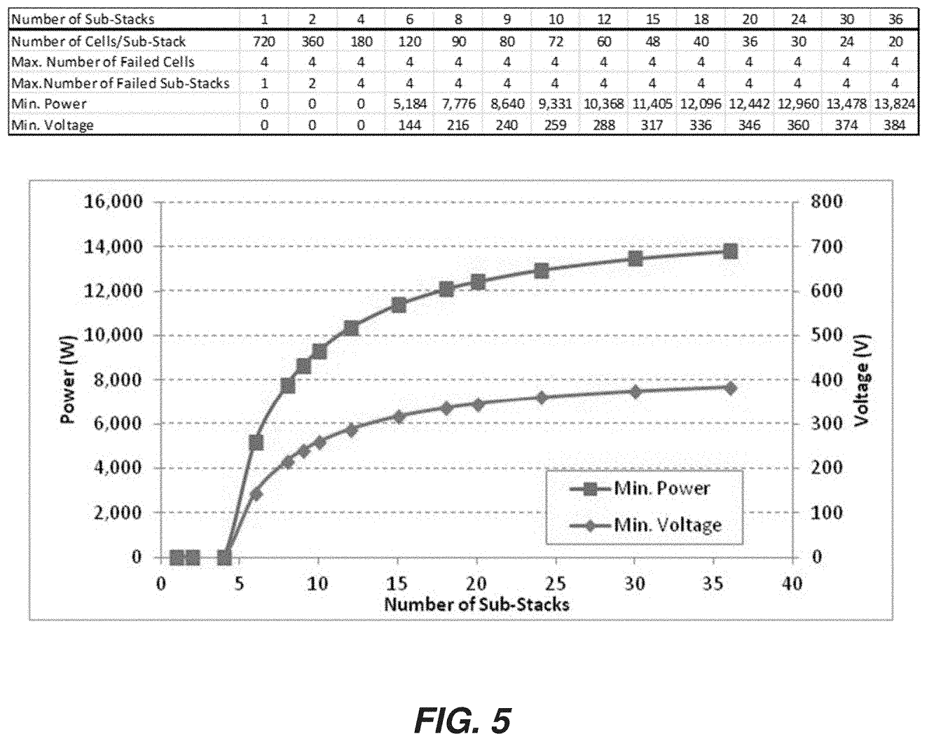

The relationship between power and the number of sub-stacks 210 in this embodiment is shown in FIG. 5. As the number of sub-stacks 210 increases, the minimum available power also increases. In the embodiment shown in FIG. 5, with 36 total sub-stacks 210, the fuel cell power system 100 is still able to produce 89% of rated power even after four sub-stacks fail. It is worth pointing out that the output of other sub-stacks 210 can be increased to make up for the power loss due to the failed sub-stacks, and the fuel cell power system 100 can continue to produce rated power. In contrast, a traditional fuel cell stack loses power generation capacity completely if one cell fails. It will be noted that the design of a fuel cell power system 100 can be changed according to cell failure rate. For example, as the failure rate of cells decreases, the number of sub-stacks 210 can be reduced.

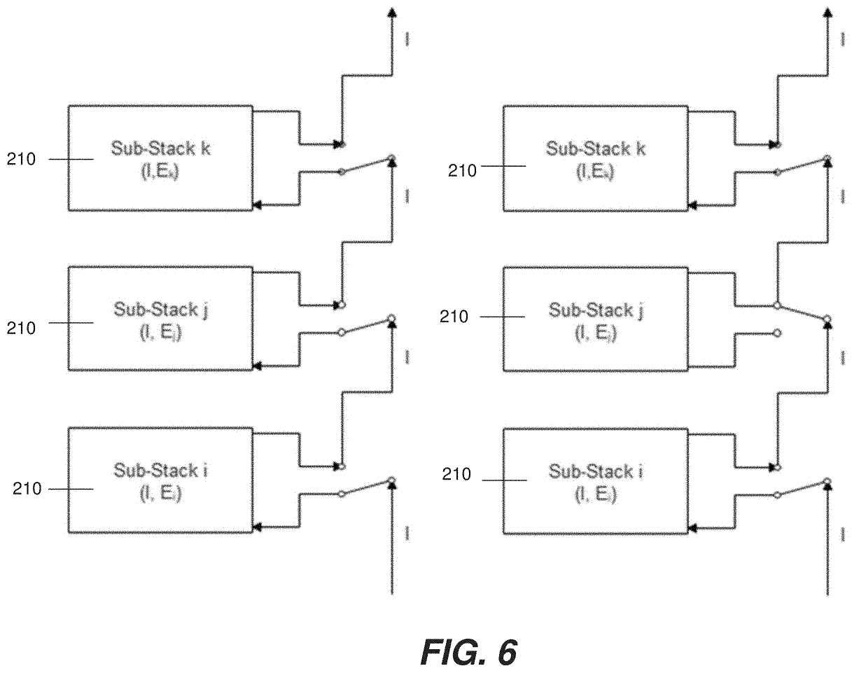

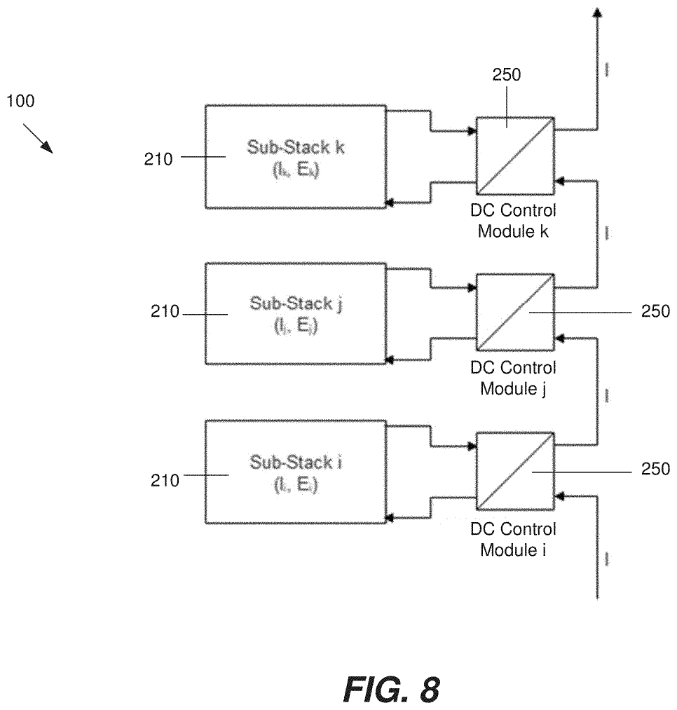

FIGS. 6-8 show different methods for connecting the sub-stacks 210 within a string 200. According to a first method shown in FIG. 6, each sub-stack 210 is connected to the power network via a single pole double throw switch. When the switch is in the down position, the sub-stack is connected in series to other sub-stacks in the network and the current flows through the stack. When the switch is in the up position, the sub-stack (e.g., sub-stack j) is disconnected from the network and the current by-passes the stack.

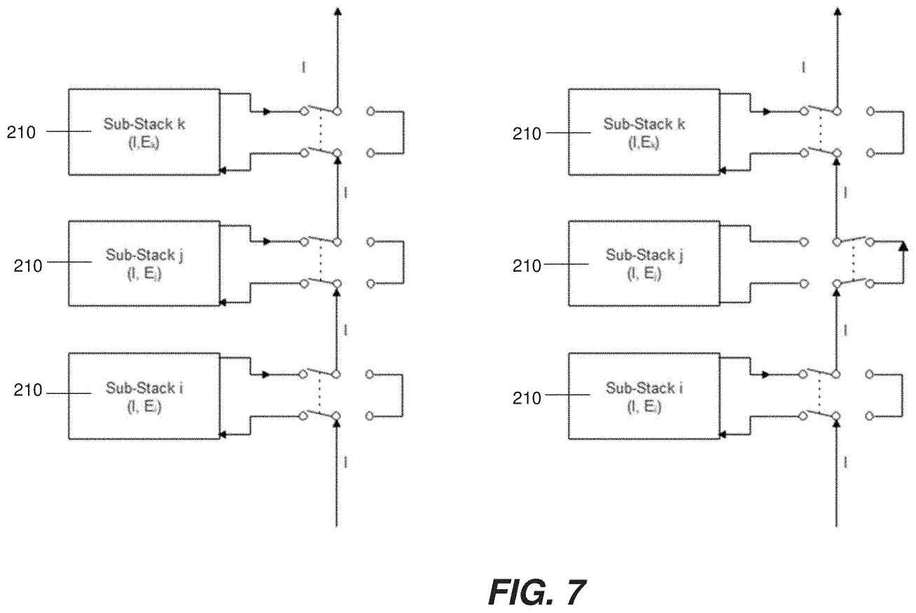

According to a second method, as shown in FIG. 7, each sub-stack is connected to the power network via a double pole double throw switch. When the switch is in the left position, the sub-stack is connected in series to other sub-stacks in the network, and the current flows through the stack. When the switch is in the right position, the sub-stack (e.g., sub-stack j) is disconnected from the network and the current by-passes the stack. According to this method shown in FIG. 7, both terminals of the sub-stack are disconnected from the network. In the method shown in FIG. 6, one terminal is still connected to the network, which might expose the sub-stack to high potentials.

According to a third method, as shown in FIGS. lA and 8, each sub-stack 210 is connected to the power network via a DC control module 250. The DC control module 250 allows the fuel cell power system 100 to continue operating if one or more sub-stacks 210 becomes weak or fails. The output of each sub-stack 210 is connected to the input of an adjustable DC control module 250. As noted above, a PCB 270 can contain multiple DC control modules 250; therefore, a PCB 270 can control more than one sub-stack 210 (provided each sub-stack is controlled by a DC control module 250 independently from other sub-stacks 210). Thus, the output of more than one sub-stack 210 may be connected to inputs of a PCB 270. The DC control modules 250 of the strings 200 are connected together in series (plus to minus, plus to minus). It will be understood that the voltage output to the external load is additive with this type of series connection.

As shown in FIG. 1A, the master system controller 260 is interfaced to the fuel cell power system 100 via a communication bus. The master system controller 260 collects voltage and current data from each DC control module 250 via the communication bus. The master system controller 260 also sends commands to each DC control module 250 to set the desired output voltage (or current) to the external load as required. Each DC control module 250 acts as an adjustable “linear power limiter” between the sub-stack 210 and the external load. The output power can be set to any value from 0% to 100% of designed output power of the sub-stack.

As the power generated by each sub-stack 210 is independently controlled by a DC control module 250, if a sub-stack 210 is low in performance, the DC control module 250 can reduce the output power of the sub-stack 210. If the sub-stack 210 fails, the DC control module 250 can reduce the output power of the sub-stack 210 to zero. According to the connection method shown in FIGS. lA and 8, the current in the power network is never interrupted so that the fuel cell power system 100 can continue operating even when a sub-stack 210 has been shut down due to cell failure. In contrast, in the embodiments shown in FIGS. 6 and 7, the current is interrupted when the switches change positions.

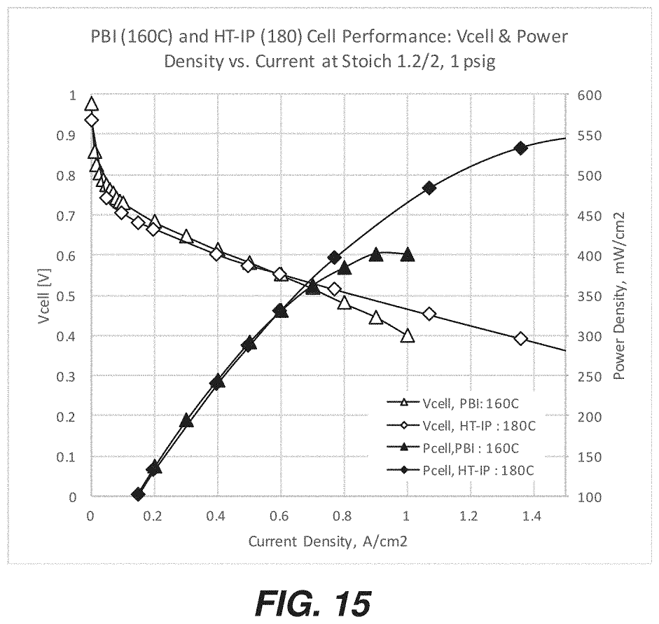

A current and voltage polarization curve can be used to determine the performance of a sub-stack 210. It will be understood that polarization curves are specific to sub-stacks, depending on a variety of factors, such as temperature, reactant flow rate and pressure. FIG. 15 shows an exemplary polarization curve for a high temperature ion-pair (HT-IP) and a polarization curve for a polybenzimizole (PBI) fuel cell. The skilled artisan is familiar with these chemistries and understands that the curves move up and down based on temperature, age and gas compositions, pressures and flow rates. The skilled artisan also understands that HT-IP and PBI have different standard polarization curves. Whether a sub-stack 210 is operating under normal conditions, weak output, or very weak output is determined based on the polarization curve for the sub-stack 210. For example, in an embodiment, if a sub-stack 210 is operating more than about 10% below the polarization curve for the sub-stack, then it might be considered as providing weak output.

The performance of each sub-stack 210 in the fuel cell power system 100 can be categorized as (1) normal if voltage for a given current of the sub-stack is greater than about 90% of the rated performance for the sub-stack, (2) weak when the voltage for a given current of the sub-stack is less than about 90% of the rated performance for the sub-stack, and greater than about 70% of the rated performance for the sub-stack, or (3) very weak when the voltage for a given current of the sub-stack is less than about 70% of the rated performance for the sub-stack. It will be understood that the rated performance for a sub-stack is provided by a polarization curve for the sub-stack at the given current. Examples of polarization curves are shown in FIG. 15.

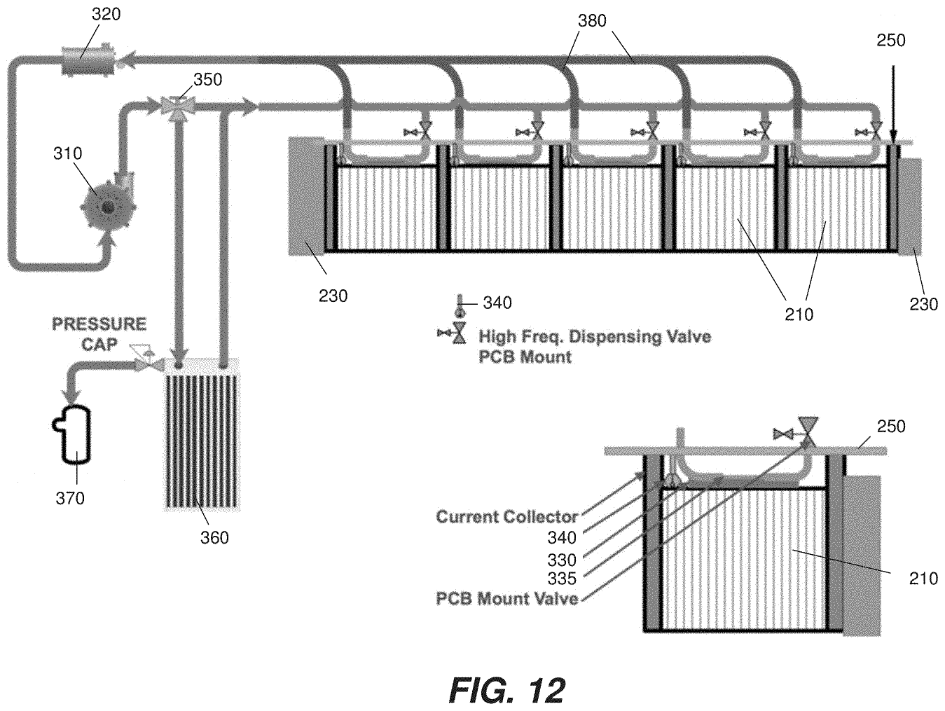

Sensors (e.g., 278, 281) that are built into the PCB 270, which also includes the DC control module 250, are used to monitor both current and voltage input into and output from the DC control module 250. In one embodiment, a dsPIC30F3013 chip, which is commercially available from Microchip Technology Corporation of Chandler, Ariz., is used as the DC control module 250 processor chip. Other suitable chips include the MSP430 chip (commercially available from Texas Instruments Inc. of Dallas, Tex.), the 3S12HZ128 chip (commercially available from Freescale Semiconductor, Inc., now NXP Semiconductor N. V. of Eindhoven, Netherlands), and the ST10 chip (commercially available from STMicroelectronics of Geneva, Switzerland). Different sensors 340 (FIG. 12) can be used to monitor the temperature of a sub-stack 210.

It will be understood that the current and voltage input into the DC control module 250 is from the sub-stack 210 and the current and voltage output from the DC control module 250 is to the external load. The data is sent via a bus between the DC control module 250 and the master system controller 260. According to a preferred embodiment, a serial communications bus is used. Other possible data buses include SPI and I²C buses.

Under normal operation, a sub-stack 210 is capable of supplying power to the load with the sub-stack at about 90% of rated performance. When operating in a weak power output state, the sub-stack 210 supplies reduced power to the load with the sub-stack at about 70%-90% of rated performance. When operating in a very weak power output state, the sub-stack 210 supplies power to the load with the sub-stack at less than about 70% of rated performance.

The DC control module 250 also has temperature control capability. At startup, the master system controller 260 sends the desired setpoint temperature to the DC control modules 250. According to an embodiment, using a sensor temperature 340, the DC control module 250 reads the temperature of a sub-stack 210 at least once per second. The master system controller 260 can turn on a pump or fan (if the temperature is below setpoint) to regulate the temperature of the sub-stack 210. In another embodiment, the temperature of a sub-stack 210 can be regulated using fluid flow, as will be described in more detail below.

In the fuel cell power system 100, the master system controller 260 monitors the output voltage of each sub-stack 210. If the performance of the sub-stack 210 is normal, the master system controller 260 sends commands to each DC control module 250, which sets the desired voltage output to the load.

In a fuel cell power system 100 with DC control modules 250, if a sub-stack 210 becomes weak and cannot supply enough voltage/power to the load, the master system controller 260 can command the DC control module 250 to draw less power from the weak sub-stack 210. Using a “Vari-Power” circuit (see FIG. 1D), the DC control module 250 lowers the output power relative to the designed output power in steps until the performance of the sub-stack 210 is normal. It will be understood that as output power is reduced, the voltage will increase. The sub-stack 210 can then run safely in this reduced power state without a shutdown of the fuel cell power system 100. It will be noted that the “Vari-power” circuit can adjust the output power relative to the designed output power to any point between 0 and 100% of the design output power.

If the performance of a sub-stack 210 is very weak, then the output power relative to the designed output power may drop to zero. When there is a very weak sub-stack 210, the master system controller 260 commands the DC control module 250 controlling the very weak sub-stack 210 to activate the DC control module's 250 “bypass switch” (see FIG. 1A) and the very weak sub-stack 210 will no longer supply any power to the external load. The “bypass switch” is a high-speed solid-state device. Unlike other switching devices, switching this type of “bypass switch” from ‘on’ to ‘off’ will not create potentially harmful voltage spikes or surges to the external load. The master system controller 260 can command the DC control modules 250 in the system 100 to increase the output power of the other sub-stacks 210 in the system 100 to compensate for the loss of the very weak sub-stack 210. If full power is desired even with a weak or very weak sub-stack 210 in the system 100, the DC control modules 250 can shut down the weak or failed sub-stack 210 and adjust the output power of other sub-stacks 210 using the “Vari-power” circuit.

Heat is generated when a fuel cell produces electricity. Thus, to maintain desired fuel cell operating temperatures, excess waste heat must be removed. The thermal management of a fuel cell can be conducted by a variety of methods, including air-cooling or liquid cooling, depending on the power outputs and applications. For high power transportation fuel cells, liquid cooling is preferred as liquids have high thermal conductivity and heat capacity. A thermal management system 300, such as the one shown in FIG. 12, can be used for such applications. A thermal management system 300 can be used to control the temperature of the stack. According to an embodiment of the thermal management system 300 shown in FIG. 12, the thermal management system 300 includes a pump 310, an electric heater 320, a thermostat 350, a radiator 360, and an expansion tank 370. As described in more detail below, a cooling plate can be used to remove heat from the sub-stacks 210. However, in the embodiment shown in FIG. 12, instead of a cooling plate, multiple heat spreaders 330 located between heat pipes 335 and sub-stacks 210 to aid in cooling.

A mixture of ethylene glycol and water, for example, can be used as a heat transfer fluid. During startup of the fuel cell power system 100, the thermal management system 300 can heat the sub-stacks 210 to operating temperatures. A suitable temperature range for operating temperature of the sub-stacks 210 is up to 300° C. In another embodiment, a suitable operating temperature of the sub-stacks 210 is 80° -240° C. In still another embodiment, a suitable operating temperature of the sub-stacks 210 is about 120°-180° C. During the power generation state, the thermal management system 300 maintains the operating temperatures of the sub-stacks 210 by supplying heat to or removing heat from the sub-stacks 210.

Liquid coolants can be used to remove the heat from the sub-stacks 210 and dissipate the heat to ambient air through a radiator 360. In some embodiments, the sub-stacks 210 can operate at temperatures up to 300° C. and the coolant temperature can be greater than 150° C. In some embodiments, the size of the radiator for the fuel cell power system 100 can be much smaller than that of a low temperature fuel cell, which typically operates at 80-90° C.

Two-phase cooling can also be used to remove heat from the sub-stacks 210 described herein. In the cooling rail 380, a portion of the coolant is transformed into vapor upon heating, resulting in a vapor/liquid mixture. Compared to single-phase liquid cooling, two-phase cooling increases heat dissipation for a given amount of fluid because the latent heat of vaporization can be orders of magnitude larger than the specific heat of the liquid. The two-phase cooling reduces coolant flow rate and thus coolant pump power consumption. In addition, two-phase cooling increases heat transfer coefficients and improves temperature uniformity.

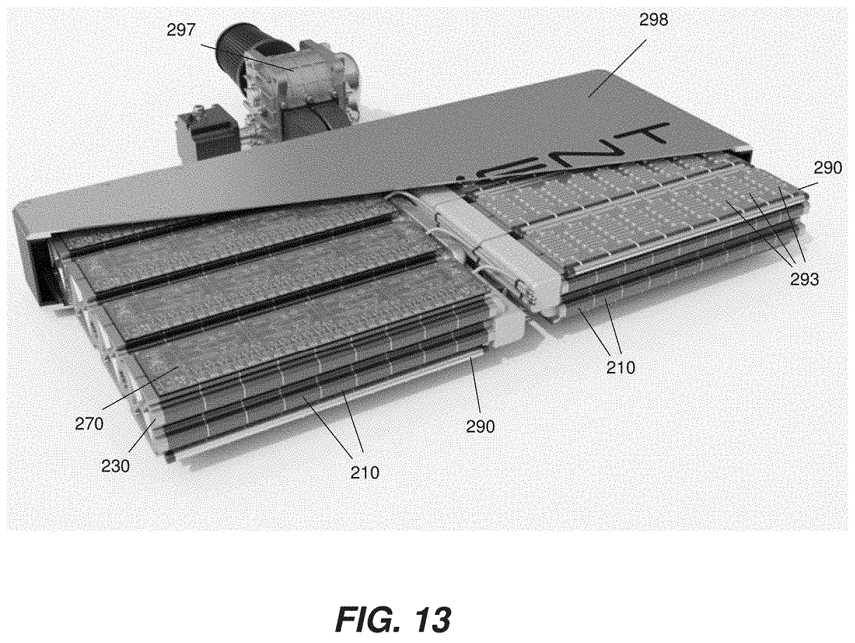

Typically, cooling channels are integrated into traditional fuel cell stacks with a cooling plate inserted at regular intervals in the stacks. According to some embodiments, the sub-stacks 210 can use edge cooling, where a cooling plate 290 is attached to the sides of the sub-stacks 210 and removes heat from the edges of the sub-stacks 210, as shown in FIG. 13. FIG. 13 is a perspective cut-away view of an embodiment of a fuel cell power system 100, which includes a blower 297. As illustrated in FIG. 13, the insulation package 298 is cut away to show the internal components of the fuel cell power system 100.

Compared to internal stack cooling, edge cooling has several benefits. Edge cooling eliminates issues with sealing the stack and also improves reliability. Because an edge cooling plate 290 is electrically isolated from the sub-stack 210, electrical conductivity of the coolant is not an issue. Therefore, there are more options for coolant selection, as there is no need to have coolant treatment in the cooling loop to reduce electrical conductivity. The coolant can be organic aqueous solutions, such as ethylene glycol/water and propylene glycol/water, or inorganic aqueous solutions, such as potassium formate/water. The operational temperatures of these fluids are in the range of about −50° C. to 220° C.

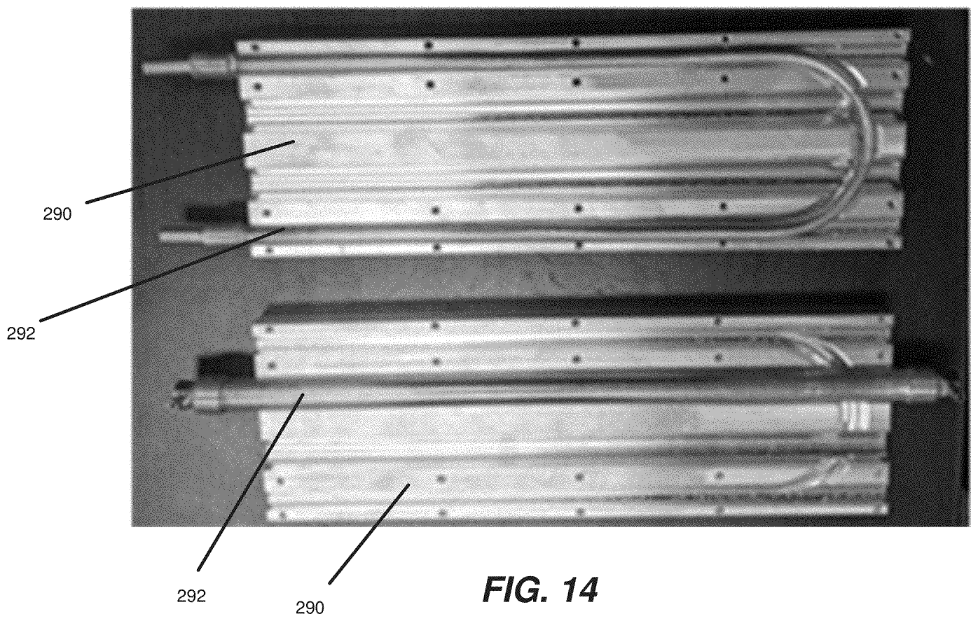

Thermal management features 293, such as heat pipes, liquid coolants, forced air, and two-phase fluids, can be embedded in edge cooling plates to aid in cooling. Heat pipes have very high surface areas. Thus, commercial heat pipes can be modified to be used in the edge cooling design. For example, modified heat pipes 292 with open ends can be embedded in an aluminum plate 290, as shown in FIG. 14. FIG. 14 shows two different versions of heat pipes 292 attached to an aluminum plate 290. The heat pipe 292 can be either a U-shaped pipe or a straight pipe, as shown in FIG. 14. The high internal surface area of the heat pipe 292 facilitates heat transfer from the plate to the coolant within the heat pipe 292.

In the illustrated embodiment of FIG. 13, there are nine sub-stacks 210 in the string 200. A single cooling plate 290 can be provided for a string 200. The cooling plate 290 for edge cooling can be divided into nine zones, with one zone for each sub-stack 210. Each zone is responsible for controlling the temperature of its corresponding sub-stack 210. As the heat generation can vary among sub-stacks, the coolant flow rate into each zone can be individually adjusted to maintain the desired temperature of the sub-stack 210. According to some embodiments, each zone of the cooling plate 290 has its own thermal management feature 293 so that the coolant flow rate into each zone can be individually adjusted. In the embodiment shown in FIG. 13, the thermal management features 293 in each zone are serpentine-shaped. In the embodiments shown in FIG. 14, the heat pipes 292 are U-shaped and straight. It will be understood that thermal management features 293 can be any suitable shape. In some embodiments, heat pipes can be used to transfer heat from the sub-stacks 210 to a heat exchanger where the heat can be dissipated.

The fuel cell power system 100 can be in either an operating or a non-operating mode. The primary operating modes include an operational state (substantial electrical output power) and a pre-generation state (zero net power output). Non-operating modes include a cold state, a passive state, and a storage state. According to an embodiment, there are two primary transitions between an operating and a non-operating mode: startup and shutdown. Startup is the transition from non-operating to operating mode and shutdown is the automatic transition from operating to non-operating mode.

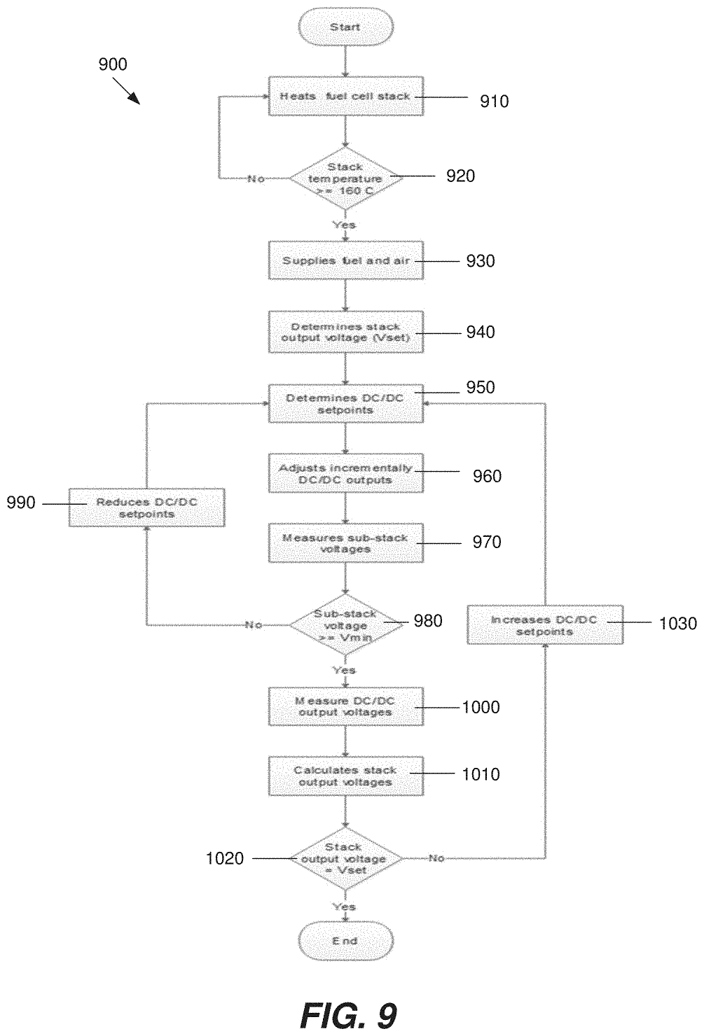

The startup procedure 900 of the fuel cell power system 100 is shown in FIG. 9. In step 910, the master system controller 260 commands the DC control modules 250 to use the thermal management system 300 to heat the sub-stacks to operating temperature (e.g., about 160° C.). In step 920, the DC control module 250 checks whether the fuel cell sub-stack 210 has reached the operating temperature. If it has reached the operating temperature, then the startup procedure 900 continues to step 930. If it has not reached the operating temperature, the thermal management system continues to heat the sub-stack 210. After the sub-stack 210 reaches the temperature setpoint, fuel (e.g., hydrogen) and oxidant (e.g., air) are supplied to the sub-stack 210 in step 930 via the manifolds 240.

The output voltage of the sub-stack 210, Vset, is determined based on the external load in step 940. In step 950, the initial outputs of DC control modules 250 are set to the minimum value of their operating ranges. The DC control modules 250 incrementally increase their outputs in step 960. The voltages of all sub-stacks 210 are measured in step 970. In step 980, it is determined whether the voltage of a sub-stack 210 is less than a pre-determined minimum value, Vmin. If the voltage of a sub-stack 210 is less than a pre-determined minimum value, Vmin, the output of the DC control module 250 will be changed to the previous setpoint in step 990. The adjustment continues until the voltages of all sub-stacks 210 are greater than Vmin. The output voltages of all DC control modules 250 are measured in step 1000. Since the converters are connected in series electrically, the currents flowing through the output sides of DC control modules 250 are identical. The voltages of the of all DC control modules 250 are added together in step 1010, as the sum of these voltages is the output voltage of the whole string 200. In step 1020, it is determined whether the voltage of the string 200 is less than the desired Vset. If the voltage of the string 200 is less than the desired Vset, the output of the DC control modules 250 will be increased incrementally in step 1030 until the voltage reaches Vset. The process is repeated until the output of the entire string 200 reaches Vset. The output power is calculated by multiplying the output voltage to the output current, which is measured using a current sensor.

The control sequence of the fuel cell power system 100 in the operational state is similar. Sub-stacks 210 are monitored and adjusted continuously by the master system controller 260 and DC control modules 250 to maintain the operating temperatures and output voltage.

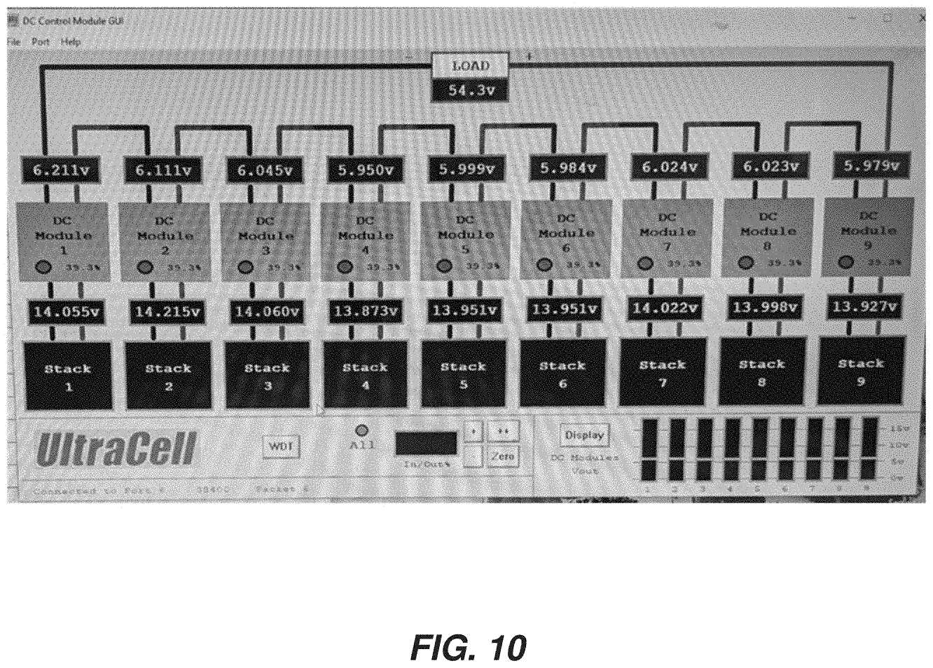

An example of a graphical user interface (GUI) for controlling the fuel cell power system 100 is shown in FIG. 10. The GUI displays the voltages of the sub-stacks 210 and DC control modules 250. Using the GUI, a user can change the outputs of DC control modules 250. For example, outputs were set to 39.3% in the example shown in FIG. 10. The output of each of the DC control modules 250 can be controlled individually. Any number of sub-stacks 210 can be shut off by the DC control module(s) 250 and generate no power while the rest of sub-stacks 210 continue to produce power without interruption. Alternatively, the DC control module(s) 250 can reduce the power generated by any of the sub-stacks 210.

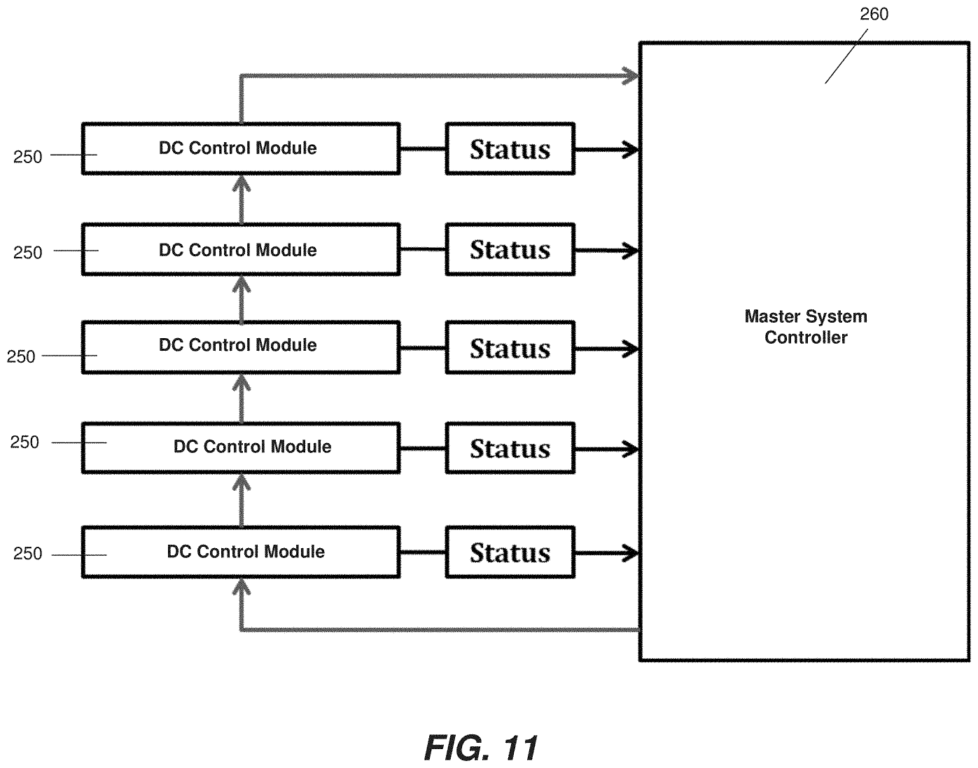

The control system of the fuel cell power system 100 includes the master system controller 260 and multiple DC control modules 250, as shown in the schematic diagram of FIG. 11. In an embodiment, each sub-stack DC control module 250 is mounted directly on a sub sack 210 and controls the sub-stack 210 on which it is mounted. In other embodiments, a PCB 270 can contain multiple DC control modules, and the PCB 270 can control more than one sub-stack 210, but each sub-stack 210 is controlled individually by its own DC control module 250 (i.e., a sub-stack can be shut off while others controlled by the same DC control module remain on). These DC control modules 250 receive data from sensors measuring process variables, such as temperature, current, and voltage, of their corresponding sub-stacks 210, and send the data to the master system controller 260. As noted above, the sensors built into a PCB 270 are used to monitor both current and voltage input into and output from the DC control module 250. The master system controller 260 analyzes the data, decides control actions to be performed (e.g., shut down of a sub-stack, cooling a sub-stack, heating a sub-stack), and sends the control instructions to the sub-stack DC control modules 250, which control the final control elements, such as valves and switches of the sub-stack 210.

It will be noted that the relationship between the voltage and current of a fuel cell can be shown by polarization curves. Different equations (for example, V=Eoc −ir−A·Iln(i) +mexp(ni)) can be used to fit experimental data. In addition to current, the voltage of a fuel cell is affected by operating conditions, such as temperature, pressure, flow rate, and reactant composition. The performance of the fuel cell decays over time as the fuel cell ages. Machine learning can be used to predict fuel cell voltage. TinyML is a type of machine learning that can run on small, low-powered devices, such as microcontrollers. Provided with an appropriate data set, machine learning models can be uploaded into a microcontroller and used to predict the fuel cell voltage in real-time based on data collected from the process sensors.

In view of all of the foregoing, it should be apparent that the present embodiments are illustrative and not restrictive and the invention is not limited to the details given herein, but may be modified within the scope and equivalents of the appended claims.

Wwhat is claimed is:

1. A fuel cell power system, comprising:
at least one fuel cell string, wherein the at least one fuel cell string comprises a plurality of fuel cell sub-stacks, wherein the sub-stacks are electrically isolated from one another and each sub-stack comprises a plurality of fuel cells;
a plurality of DC control modules configured to control the sub-stacks, wherein outputs of the DC control modules are connected in series and wherein a different DC control module is configured to control each sub-stack, wherein each of the DC control modules is capable of controlling a magnitude of output power of its corresponding sub-stack independently of other sub-stacks; and
a master system controller in communication with the plurality of DC control modules, wherein the master system controller receives data from the DC control modules and sends commands to the DC control modules.

2. The fuel cell power system as recited in claim 1, further comprising at least one circuit board on which the DC control modules are mounted.

3. The fuel cell power system as recited in claim 2, comprising a plurality of printed circuit boards, wherein each DC control module is mounted on a different printed circuit board.

4. The fuel cell power system as recited in claim 2, wherein the at least one printed circuit board is mounted directly on the plurality of sub-stacks.

5. The fuel cell power system as recited in claim 1, wherein the fuel cells are polymer electrolyte membrane fuel cells having a membrane electrode assembly.

6. The fuel cell power system as recited in claim 1, comprising a plurality of fuel cell strings wherein the fuel cell strings are electrically connected in series, parallel, or a combination of series and parallel.

7. The fuel cell power system as recited in claim 1, further comprising a thermal management system configured to regulate a temperature of the sub-stacks.

8. The fuel cell power system as recited in claim 7, wherein a cooling plate is attached to an edge of the sub-stacks to remove heat from the sub-stacks, wherein a thermal management feature is embedded in the cooling plate.

9. The fuel cell power system as recited in claim 8, wherein the thermal management feature is selected from the group consisting of: a heat pipe, liquid coolant, forced air, and two-phase fluid.

10. The fuel cell power system as recited in claim 9, wherein the thermal management feature is a heat pipe embedded in the cooling plate and liquid flows through the heat pipe.

11. The fuel cell power system as recited in claim 8, wherein the cooling plate is divided into a plurality of zones, wherein each zone is configured with its own thermal management feature to regulate a temperature of one sub-stack independently.

12. A method of controlling a fuel cell power system comprising a plurality of fuel cell sub-stacks, the method comprising:
monitoring a voltage output and a current output from each of the sub-stacks;
monitoring a temperature of one or more of the sub-stacks;
reducing an output power of a sub-stack if the voltage for a given current of the sub-stack is greater than about 70% of rated performance for the sub-stack and less than about 90% of rated performance for the sub-stack while other sub-stacks output more than about 90% of rated performance, wherein the rated performance for the sub-stack is provided by a polarization curve for the sub-stack at the given current; and
shutting off the output of a sub-stack if the voltage for a given current of the sub-stack is less than about 70% of rated performance for the sub-stack while other sub-stacks output more than about 90% of rated performance for the sub-stack.

13. The method as recited in claim 12, wherein the output power of the sub-stack is reduced incrementally until a voltage is increased to at least about 90% of rated performance for the given current.

14. The method as recited in claim 12, wherein the output of the sub-stack is shut off by sending a command to a DC control module configured to control the sub-stack to activate a bypass switch to shut off the output of the sub-stack.

15. The method as recited in claim 14, wherein a master system controller commands other DC control modules in the system to increase an output power of other sub-stacks in the system.

16. A fuel cell power system, comprising:
at least one fuel cell string, wherein the at least one fuel cell string comprises a plurality of fuel cell sub-stacks, wherein the sub-stacks are electrically isolated from one another and each sub-stack comprises a plurality of fuel cells;
a plurality of DC control modules configured to control the sub-stacks, wherein outputs of the DC control modules are connected in series and wherein a different DC control module is configured to control each sub-stack, wherein each of the DC control modules is capable of reducing an output power of its corresponding sub-stack independently of other sub-stacks if performance of the corresponding sub-stack is below about 90% of rated performance for the sub-stack while other sub-stacks output more than about 90% of rated performance, wherein the performance is voltage output for a given current of the sub-stack and the rated performance for the sub-stack is provided by a polarization curve for the sub-stack at the given current; and
a master system controller in communication with the plurality of DC control modules, wherein the master system controller receives data from the DC control modules and sends commands to the DC control modules.

17. The fuel cell power system as recited in claim 16, wherein each of the DC control modules is capable of shutting down an output power of its corresponding sub-stack independently of other sub-stacks if performance of the corresponding sub-stack is below about 70% of rated performance for the sub-stack while other sub-stacks output more than about 90% of rated performance.

18. The fuel cell power system as recited in claim 16, wherein each of the DC control modules can reduce an output power of a sub-stack incrementally until a voltage is increased to at least about 90% of rated performance for the given current.

19. The fuel cell power system as recited in claim 17, wherein the master system controller sends a command to a DC control module configured to control the sub-stack to activate a bypass switch to shut off the output of the sub-stack.

20. The fuel cell power system as recited in claim 19, wherein the master system controller commands other DC control modules in the system to increase an output power of other sub-stacks in the system.
